(19) United States
(12) Patent Application Publication
(10) Pub. No.: US 2007/0053018 A1
(43) Pub. Date: Mar. 8, 2007

(54) Method for scanning selected target image area of document

(76) Inventor: Jen-Shou Tseng, Chunan Town (TW)

Correspondence Address: BERKELEY LAW & TECHNOLOGY GROUP, 1700NW 167TH PLACE, SUITE 240, BEAVERTON, OR, 97006, US

(21) Appl. No.: 11/506,359

(22) Filed: Aug. 18, 2006

Related U.S. Application Data
(63) Continuation of application No. 09/984,100, filed on Oct. 29, 2001.

(51) Int. Cl. H04N 1/04

(52) U.S. Cl. 358/486

(57) ABSTRACT

A method for scanning a selected target image area of a document includes steps of establishing in a scanner a first optical path by a first focusing lens; using the first focusing lens to preview the document and select from the whole document image a selected image area; moving the first focusing lens out of the first optical path and move a second focusing lens into the optical path to establish a second optical path in the scanner; and using an optical scanning module in the scanner and the second focusing lens to scan the selected image area of the document to obtain the desired target image.

### BACKGROUND OF THE INVENTION

1. Field of the Invention

The present invention relates to an image scanning method, and more particularly to a method for scanning a selected target image area of a document.

2. Description of the Prior Art

A scanner is widely employed in office automation to scan pictures, documents, and many other images. FIG. 1 shows a typical flat-bed scanner that mainly includes a frame 1 having a top plate 11 provided at a central area with a rectangular window area of predetermined size. A transparent sheet glass is mounted on the window area to serve as a document-supporting surface 12, onto which a document to be scanned is positioned. A key pad 13 including different operating keys is normally provided at a proper position on the top plate 11 of the frame 1.

The frame 1 of the scanner is internally provided with an optical scanning module 21, a reflection module 22, a pair of guide bars 23, a focusing lens 24, a scanning light source 25, and an image sensing device 26, such as a charge-coupled device (CCD). The scanning light source 25 supplies light source needed in scanning. The optical scanning module 21 and the reflection module 22 are driven by a control circuit of the scanner and a known driving mechanism to move along the guide bars 23 in a first direction I, so as to scan the document laid on the surface 12.

FIG. 2 schematically shows an optical path established in the scanner of FIG. 1 for scanning. Light beams emitted from the scanning light source 25 are reflected from the document 10 to be scanned and then be focused by the focusing lens 24. The focused light beams are then received by the image sensing device 26. In the process of scanning, an optical path 3 is established among the document 10, the focusing lens 24, and the image sensing device 26.

With the above-described conventional scanner, it is impossible to scan and magnify only a localized area of the document 10 to obtain a target image. In the known scanning technology, there is a scanner adopting dual focusing lens in order to obtain two scanning resolutions. However, an actual scanning output is limited to the resolutions of the dual focusing lens.

Therefore, it is desirable to provide a method of permitting scanning and magnifying of a selected target image area of a document to be scanned to obtain a desired target image thereof.

### SUMMARY OF THE INVENTION

A primary object of the present invention is to provide a method of scanning a localized area of a document with a scanner. In the scanning method, a localized area showing a target image is selected from a whole image of the document to be scanned, and the selected area is scanned to obtain the desired target image.

Another object of the present invention is to provide a method of scanning and magnifying a target image. In the method, a first focusing lens is used to preview a whole image of a document to be scanned, in order to find the position of a target image on the whole image. The first focusing lens is then moved out of the optical path and a second focusing lens is moved into the optical path to locate at a desired position adapted to bring the selected target image into focus, and then the target image is scanned.

To achieve the above and other objects, the method according to the present invention for scanning and magnifying a selected target image of a document mainly includes steps of providing a scanning light source for scanning to establish a first optical path among the optical scanning module, the first focusing lens, and the image sensing device, so as to form a first object image on the image sensing device; previewing the image of the document by using the first focusing lens; selecting the target image area from the image of the document; moving the first focusing lens out of the first optical path; moving the second focusing lens to a position so that a second optical path is established among the optical scanning module, the second focusing lens, and the image sensing device, so as to form a second object image on the image sensing device, the second object image being reverse to the first object image; and scanning the selected target image area of the document by using the second focusing lens. Alternatively, a single focusing lens may be used to replace the first and the second focusing lenses. In this case, the single focusing lens is reverted to perform scanning of the selected target image area.

### BRIEF DESCRIPTION OF THE DRAWINGS

The present invention will be described in further detail with reference to the accompanying drawings, wherein:

FIG. 1 is a perspective view of a conventional scanner;

FIG. 2 schematically shows the optical path in the scanner of FIG. 1 for scanning a document;

FIG. 3 is a perspective view of a scanner for implementing the method of the present invention for scanning a localized area;

FIG. 4 schematically shows the optical path in the scanner of FIG. 3 and the relative positions of a first focusing lens, a second focusing lens, a document to be scanned, and an image sensing device in the optical path in accordance with a first embodiment of the present invention;

FIG. 5 schematically shows a first path established in the scanner of FIG. 3 for scanning a complete image of a document in accordance with the first embodiment of the present invention;

FIG. 6 schematically shows a second path established in the scanner of FIG. 3 for scanning a localized image of a document in accordance with the first embodiment of the present invention;

FIG. 7 is a flowchart showing steps included in the first embodiment of the present invention;

FIG. 8 schematically shows a first path established in the scanner of FIG. 3 for scanning a complete image of a document in accordance with the second embodiment of the present invention;

FIG. 9 schematically shows a second path established in the scanner of FIG. 3 for scanning a localized image of a document in accordance with the second embodiment of the present invention; and

FIG. 10 is a flowchart showing steps included in the second embodiment of the present invention.

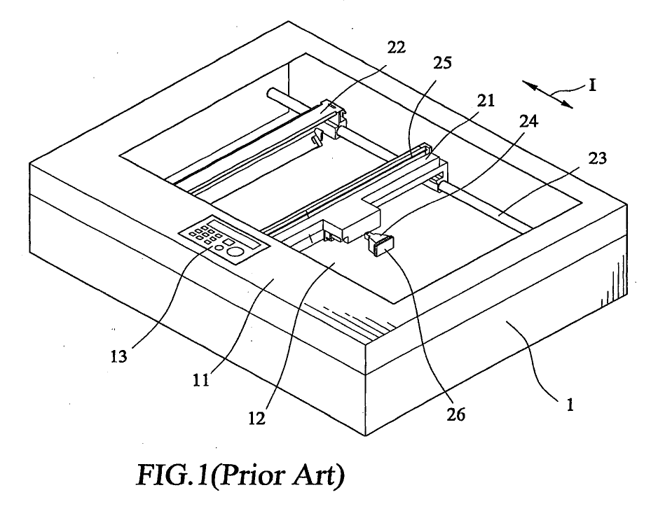

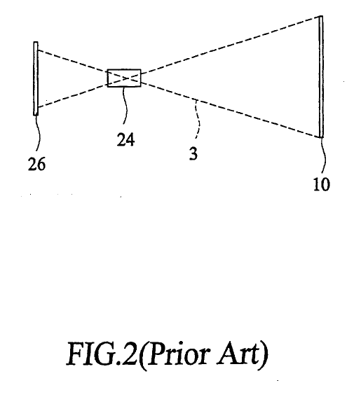

### DETAILED DESCRIPTION OF THE PREFERRED EMBODIMENTS

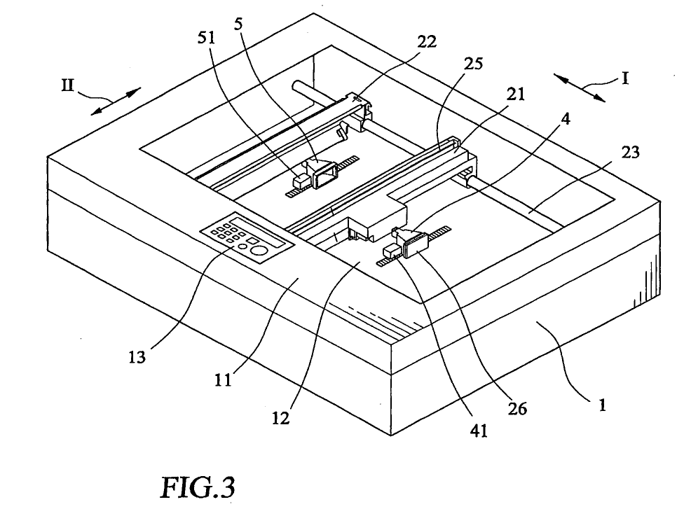

Please refer to FIG. 3 that is a perspective view of an image scanning device employing the method of scanning a selected target image of a document in accordance with a first embodiment of the present invention. As shown, the scanner 1 mainly includes an optical scanning module 21, a reflection module 22, a pair of guide bars 23, a scanning light source 25, and an image sensing device 26. The optical scanning module 21 and the reflection module 22 are driven by a control circuit in the scanner 1 and a driving mechanism known in the art to move along the guide bars 23 in a first direction I, so as to scan a document laid on a document supporting surface 12 to be scanned.

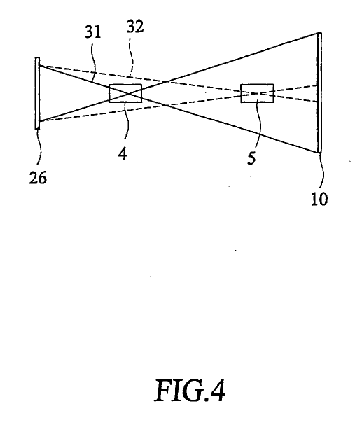

In an optical path provided in the scanner 1, there is arranged two focusing lens, namely, a first focusing lens 4 being located close to the image sensing device 26, and a second focusing lens 5 being located close to an object image of the document to be scanned. FIG. 4 shows positions of the first and the second focusing lens 4, 5 relative to the document 10 to be scanned and the image sensing device 26 in the optical path provided by the scanner 1.

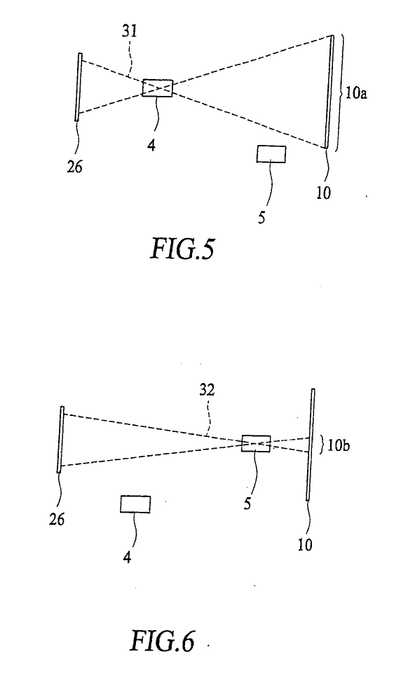

The first focusing lens 4 has a first shifting mechanism 41 associated therewith for moving the first focusing lens 4 in a second direction II, so that the first focusing lens 4 could be moved to a position between the document 10 to be scanned and the image sensing device 26 to establish a first optical path 31 in the scanner 1. FIG. 5 schematically shows the first optical path 31. Please note that the second focusing lens 5 is out of the first optical path 31. In the first optical path 31, a whole image 10a of the document 10 is formed on the image sensing device 26 of the scanner 1.

The second focusing lens 5 also has a second shifting mechanism 51 associated therewith for moving the second focusing lens 5 in the second direction II, so that the second focusing lens 5 could be moved to a position between the document 10 to be scanned and the image sensing device 26 to establish a second optical path 32. FIG. 6 schematically shows the second optical path 32. Please note that the first focusing lens 4 is out of the second optical path 32. In the second optical path 32, a selected partial image 10b selected from the whole image of the document 10 is formed on the image sensing device 26 of the scanner 1.

Both the first and the second shifting mechanisms 41, 51 include, for example, driving motors, guide rails, etc., that are known in the art. In a preferred embodiment of the scanner 1, the first and the second focusing lenses 4, 5 have different optical powers, and the first focusing lens 4 has an optical power smaller or equal to 1 (M≦1) while the second focusing lens 5 has an optical power larger than 1 (M>1). Moreover, it is possible for the first and the second focusing lenses 4, 5 to have different optical resolutions, so that the scanner 1 has the function of scanning at two resolutions.

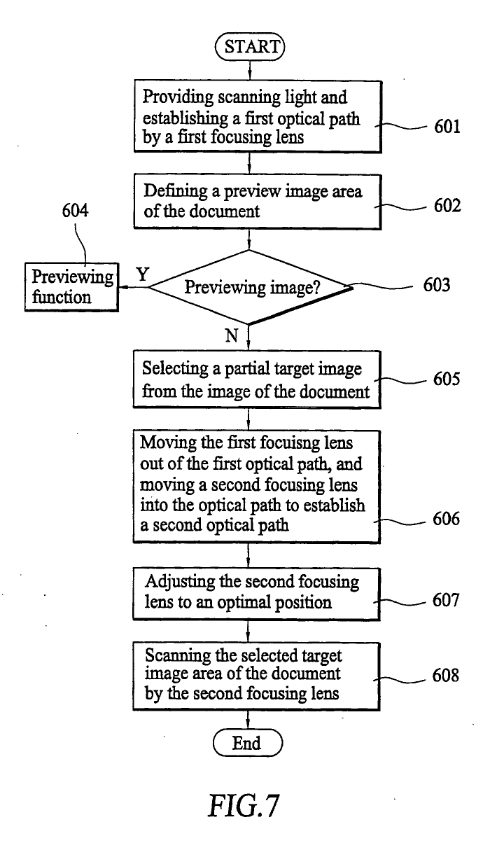

FIG. 7 is a flowchart showing steps included in the method of the present invention for scanning a selected target image area of a document with the scanner 1. When using the scanner 1 to scan a document 10 laid on the document supporting surface 12, first turn on the scanning light source 25 of the scanner 1 to provide a light source for scanning, and establish the first optical path among the document 10 to be scanned, the first focusing lens 4, and the image sensing device 26 (step 601), so as to form a first object image on the image sensing device.

After the first optical path has been established, a user may define a preview area for the document 10 to be scanned (step 602), and observes a selected image area of the whole document 10 via the first optical path. Thereafter, the user may select whether to perform the function of previewing image or not (step 603). In the case the preview function is selected, the function is performed on the scanner 1 to preview the image of the document 10 (step 604).

Based on the preview area defined for the document via the first focusing lens 4, the user may select a localized target image area from the whole image of the document to be scanned (step 605). After the desired localized target image area has been selected, use the first shifting mechanism 41 to move the first focusing lens 4 out of the first optical path, and use the second shifting mechanism 51 to move the second focusing lens 5 into the initial first optical path, so as to establish the second optical path among the document 10 to be scanned, the second focusing lens 5, and the image sensing device 26 (step 606). So, a second object image is formed on the image sensing device and the second object image formed by the second optical path is reverse to the first object image formed by the first optical path described above.

In the step of shifting the second focusing lens 5, the second focusing lens 5 is further finely adjusted with the second shifting mechanism 51 to an optimal position for forming image (step 607). Finally, use the optical scanning module 21 and the second focusing lens 5 to scan the selected target image area, so as to obtain a target image from the localized area (step 608).

It is also possible to use a single focusing lens to replace the first and the second focusing lenses 4, 5. In this case, the single focusing lens is reverted to perform scanning of the selected target image area.

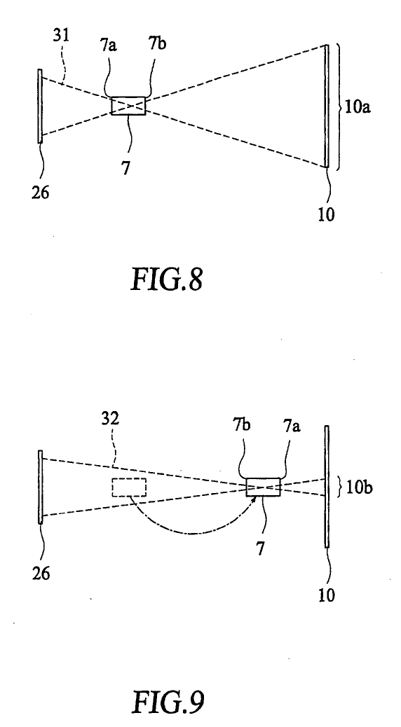

FIG. 8 schematically shows a focusing lens 7 is arranged between the image sensing device 26 and the document 10 to establish a first optical path 31 in accordance with a second embodiment of the present invention. The focusing lens 7 has a first end 7a facing to the image sensing device 26 and a second end 7b facing to the document 10 to be scanned. It is noted that the whole image 10a of the document 10 is formed on the image sensing device 26.

With reference to FIG. 9, the focusing lens 7 can be reversed by a known mechanism (not shown), such that the first end 7a thereof faces to the document 10 and the second end 7b thereof faces to the image sensing device 26. Besides, the focusing lens 7 is moved to a position close to the document 10 in the optical path, as shown, to establish a second optical path 32. In the second optical path 32, a selected partial image 10b selected from the whole image of the document 10 is formed on the image sensing device 26.

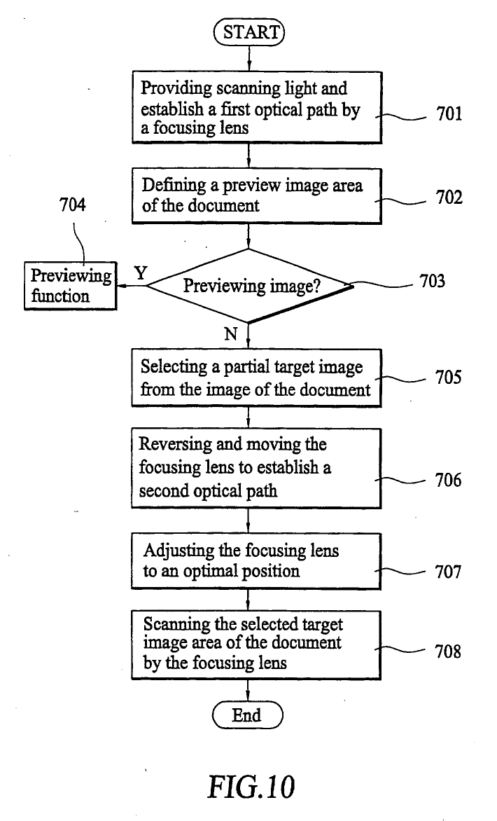

FIG. 10 is a flowchart in accordance with the second embodiment of the present invention. Similar to the performance of the first embodiment described above, the scanner first provides a light source for scanning and then establish a first optical path among the document 10 to be scanned, the first focusing lens 4, and the image sensing device 26 (step 701), so as to form a first object image on the image sensing device.

After the first optical path has been established, a user may define a preview area for the document 10 to be scanned (step 702), and observes a selected image area of the whole document 10 via the first optical path. Thereafter, the user may select whether to perform the function of previewing image or not (step 703). In the case the preview function is selected, the function is performed on the scanner 1 to preview the image of the document 10 (step 704).

Based on the preview area defined for the document via the focusing lens 7, the user may select a localized target image area from the whole image of the document to be scanned (step 705). After the desired localized target image area has been selected, the focusing lens 7 is reversed and then moved to a position close to the document 10, with reference to FIG. 9, so as to establish a second optical path among the document 10, the second focusing lens 5, and the image sensing device 26 (step 706). So, a second object image is formed on the image sensing device. The second object image formed by the second optical path is reverse to the first object image formed by the first optical path described above.

In the step of moving the focusing lens 7, the focusing lens 7 is further finely adjusted to an optimal position for forming image (step 707). Finally, use the optical scanning module 21 and the focusing lens 7 to scan the selected target image area, so as to obtain a target image from the localized area (step 708).

It is apparent that although the present invention is illustrated with the description of a preferred embodiments of the system in accordance with the present invention, it is contemplated that there may be changes and modifications in the described embodiment and examples that can be carried out without departing from the scope of the invention which is intended to be limited only by the appended claims

1.-7. (canceled)

8. A scanner, comprising:
a document supporting surface;
a first lens having a first optical power;
a first shifting mechanism coupled to the first lens to establish a first optical path between the first lens and a document disposed on the document supporting surface;
a second lens having a second optical power; and
a second shifting mechanism coupled to the second lens to establish a second optical path between the second lens and a document disposed on the document supporting surface.

9. The scanner of claim 8, further comprising:
circuitry to control the first lens and first shifting mechanism to obtain an image of a document disposed on the document supporting surface; and
circuitry to control the second lens and second shifting mechanism to obtain an image of a localized area of the document disposed on the document supporting surface.

10. The scanner of claim 8, further comprising:
a scanning light source to provide light to the document supporting surface; and
an image sensing device to receive light reflected from the document supporting surface and focused by one of the first or second lens.

11. The scanner of claim 10, wherein the first optical path includes the first lens, the document supporting surface and the image sensing device.

12. The scanner of claim 11, wherein the second optical path includes the second lens, the document supporting surface and the image sensing device.

13. The scanner of claim 12, wherein the first shifting mechanism is further adapted to move the first lens out of the second optical path.

14. An apparatus, comprising:
means for scanning an object to obtain a first object image;
means for viewing the first object image;
means for selecting a localized area of the object from the first object image; and
means for scanning a localized area of the object to obtain a second object image comprising an image of the localized area of the object.

15. An apparatus, comprising:
circuitry to control a first lens having a first optical power and a first shifting mechanism coupled to the first lens to obtain an image of an object;
circuitry to receive a selection of a localized area of the image of the object;
circuitry to control a second lens having a second optical power and a second shifting mechanism coupled to the second lens to obtain an image of a localized area of the object in accordance with the selection.

16. The apparatus of claim 15, further comprising:
a first shifting mechanism coupled to the first lens to establish a first optical path between the first lens, the object and an image sensing device; and
a second shifting mechanism coupled to the second lens to establish a second optical path between the second lens, the object and an image sensing device.

17. The apparatus of claim 16, wherein the first shifting mechanism is further adapted to move the first lens out of the second optical path.

18. The apparatus of claim 16, wherein the second shifting mechanism is further adapted to move the second lens out of the first optical path.

19. An article comprising: a storage medium, having stored thereon instructions that, when executed, result in:
establishing a first optical path between a first lens and an object disposed on a scanner;
obtaining a first object image of the object;
displaying a preview image of the first object image;
selecting a localized area of the object from the displayed preview image;
establishing a second optical path between a second lens and the object disposed on the scanner;
scanning a localized area of the object to obtain a second object image comprising an image of the localized area of the object.

20. The article of claim 19, wherein the first optical path includes the first lens, the document supporting surface and the image sensing device.

21. The article of claim 20, wherein the second optical path includes the second lens, the document supporting surface and the image sensing device.

22. The article of claim 21, wherein the instructions, when executed, further result in:
shifting the first lens out of the first optical path prior to establishing the second optical path.
